(19) United States
(12) Patent Application Publication
(10) Pub. No.: US 2002/0134209 A1
(43) Pub. Date: Sep. 26, 2002

(54) Sheet cutting process and apparatus

(76) Inventors: Allan Burman, Queensland (AU); Albert De Boer, Western Australia (AU)

Correspondence Address: LARSON & TAYLOR, PLC, 1199 NORTH FAIRFAX STREET, SUITE 900, ALEXANDRIA, VA, 22314, US

(21) Appl. No.: 09/890,152

(22) PCT Filed: Dec. 4, 2000
(86) PCT No.: PCT/AU00/01497

(30) Foreign Application Priority Data
Dec. 2, 1999 (AU) PQ4423

(51) Int. Cl. B26D 1/15

(52) U.S. Cl. 83/39; 83/408; 83/435.2

(57) ABSTRACT

A method of, and apparatus, for cutting compressed or uncompressed uncured fibre cement sheet including the steps of: (a) supporting an untrimmed fibre cement sheet (18) on a conveyor belt (19, 27, 43) formed from compressible or resilient material such as rubber in contact with a rigid support surface (28, 44) whereby the fibre cement sheet (18) is stationary on the belt (19,27,43); (b) making two or more longitudinal cuts (35, 37) by cutting wheels (39) and two or more transverse cuts (34,36) by cutting press (33) to the untrimmed sheet so as to trim at least four edges of the sheet, wherein each of said cuts are made in a vertical plane through the sheet and result in deformation of the compressible or resilient material of the conveyor belt (19, 27, 43) which contacts the rigid support surface as a result of each cut; and (c) removing the trimmed sheet (18A) from die conveyor belt. The use of a resilient conveyor belt being supported on a rigid support block enables a clean and smooth cut to be made through the fibre cement sheet.

### FIELD OF THE INVENTION

This invention relates to a sheet cutting process and apparatus and is especially directed to cutting of sheet formed of fibre cement, such as asbestos-cement sheets or fibre cement sheets containing wood fibres, e.g. cellulose fibres obtained from pine (i.e. Radiata pine).

However, the invention is applicable to fibre cement or calcium silicate sheet which contain fibres derived from any other fibrous material inclusive of natural or synthetic fibres. It will also be appreciated that the invention is particularly applicable to compressed or uncompressed uncured fibre cement sheet and calcium silicate sheet. Thus, as used herein “fibre cement sheet” includes calcium silicate sheet.

### BACKGROUND OF THE INVENTION

Fibre cement sheet is generally formed from silica, cellulose fibre, Portland cement and water and after mixing of these components and resulting hydration of the cement in a tank, the resulting mixture is then transferred to a porous conveyor belt formed from felt by various means. The mixture of raw materials is then transferred to a size roller whereby a sheet of a desired thickness may be formed. In this regard, it will be appreciated that hydration of the cement commences as soon as the mixture is formed and is an on-going process and continues until after the sheet is formed. After formation, the uncured or “green” sheet is subsequently trimmed to required dimensions before being stacked for further processing, storage and ultimate transport.

Such fibre cement sheet after being trimmed may be subjected to a compression step usually by a hydraulic press and then may be subjected to an autoclave for curing purposes. Normally such sheet after curing will have an oven dried specific gravity in the range of 0.5-1.9.

However, the “green” or uncured sheet is relatively soft in structure prior to autoclaving and care must be taken during the trimming operation not only to achieve a clean cut but also avoid damage to the sheet structure.

Conventional cutters used for the trimming operation include water jets which are relatively messy in operation and which take away a certain amount of the sheet in slurry form, and power driven circular saws or blades which are also messy in operation creating dust or swarf. There is also used guillotines as well as cutting presses which, like water jets and circular blades, have a fundamental disadvantage in that they often do not achieve a clean cut through the sheet in the trimming operation.

In one conventional method, a cutting press was used having four adjustable cutting blades which were arranged in a rectangular array. There were also provided two linked carriages which moved from an initial location wherein a first carriage was located in advance of, or in front of, the cutting press and a second carriage was located directly below the cutting press to a final location wherein the first carriage was located below the cutting press and the second carriage was located below a conveyor belt which was used to transfer an untrimmed sheet from the conveyor belt onto the second carriage. The process involved the following steps:

(i) the untrimmed fibre cement sheet was deposited onto the second carriage by the conveyor belt as the second carriage moved out from under the conveyor belt. When the second carriage stopped at its location below the cutting press the previously trimmed fibre cement sheet was removed from the first carriage for transfer to another location, such as a transportation location or storage location;

(ii) the untrimmed sheet on the second carriage was trimmed by downward movement of the cutting press;

(iii) the trimmed sheet was then lifted up from the second carriage by suction applied via the cutting press by a suction fan;

(iv) the pair of carriages then moved from the initial location to the final location wherein the trimmed sheet was then deposited on the first carriage by the cutting press by removal of the suction; and

(v) the pair of carriages then moved back to the initial location wherein step (i) was then repeated.

The abovementioned conventional procedure was found to be deficient for a number of reasons:

(a) the necessity to ensure that the first and second carriages moved synchronously with respect to the conveyor belt to accurately locate the untrimmed sheet on the second carriage was difficult to achieve consistently in practice;

(b) using suction to lift the sheet up in step (iii) often damaged the edges of the sheet;

(c) the life of the cutting blades of the cutting press was relatively short largely because of contact with the carriage which was formed from metal or high density polyethylene;

(d) it was often necessary and often difficult to scrape or remove all of the swarf from the second carriage after the cutting step;

(e) the procedure was complicated having regard to the use of two linked carriages together with a synchronously driven conveyor and was also expensive to instal and maintain;

(f) the procedure was subject to relatively long cycle times, i.e. around 14 seconds in duration;

(g) it was difficult to achieve a clean cut through the fibre cement sheet because the cutting press and associated blades were often not in a plane which was exactly coplanar with the fibre cement sheet; and

(h) further trimming of the trimmed sheet after curing was often necessary to produce a finished sheet which was dimensionally accurate and uniformly edge trimmed all round.

In a patent search carried out in relation to this invention, AU 70170/81, EP 0199155 and U.S. Pat. No. 5,699,707 were located and this prior art is considered below.

AU 70170/81 refers to a method of cutting rubbery strip into segments which includes the steps of:

(i) placing rubbery strip on a surface of tensioned flexible material of a conveyor belt;

(ii) applying a hot cutting edge to a lateral dimension of the rubbery strip at an acute angle to a longitudinal axis of the conveyor belt, whereby the hot cutting edge moves in an arcuate path through the rubbery strip; and

(iii) driving the cutting edge against the surface of the tensioned flexible material to cut the rubbery strip so that the conveyor belt contacts a resilient body below the conveyor belt which resilient body bears the pressure of the hot cutting edge.

EP 0199155 refers to an automatic cutting machine for cutting into pieces a continuously advancing strand of soap or similar material. The strand of soap is supported on a conveyor belt which is driven at a higher speed than the speed at which the strand of soap is being advanced. The strand of soap is cut by a guillotine assembly which has a cutting blade which adopts an arcuate cutting path as it cuts through the strand of soap. The blade at the end of its cutting stroke avoids cutting the conveyor belt by the provision of a rigid support table located below the cutting belt which is inclined downwardly at a small angle which counterbalances movement of the blade into the conveyor belt. The conveyor belt slides over the support table which is made of a material having a low coefficient of function.

U.S. Pat. No. 5,699,707 refers to a machine and method for cutting soft sheet material such as textile material having a cutting table having a support surface with a plurality of openings. An endless conveyor belt of relatively high air permeability being formed from mesh material overlays and is movable relative to the support surface. An endless microporous support belt having relatively low air permeability overlays the conveyor belt. A vacuum source is connected to the cutting table and cooperates with the microporous support belt to retain the textile material thereon in a fixed position during transporting and cutting thereof. The vacuum source also retains the microporous support belt for uniform movement therewith. A cutting tool is supported on the cutting table for cutting the sheet material and has a washer positioned adjacent the cutting wheel to limit penetration of the cutting tool into the microporous support belt. An indexing device is provided to co-operate with the cutting tool for locating the position of the sheet material prior to cutting thereof.

The abovementioned prior art is exemplary of a conveyor belt moving over a rigid surface in the case of EP 0199155 and U.S. Pat No. 5,699,707 and in the case of a resilient support material in the case of AU 70170/81. It will be noted that each cutting apparatus disclosed is specifically designed for cutting the material of interest i.e. rubbery strip in the case of AU 70170/81 which requires a hot cutting edge being driven into the rubbery strip at an acute angle to the longitudinal axis of the belt and having an arcuate cutting path to contact a resilient support material located below the conveyor belt. In the case of EP 0199155 the conveyor belt is driven at a faster speed than the strand of soap to be cut and the cutting blade moves through the soap in an arcuate cutting path. In the case of U.S. Pat. No. 5,699,707 a vacuum source is required to apply suction through the openings of the support table to pass through apertures in a meshed conveyor belt to retain the microporous belt to retain textile sheet to be cut on the cutting table.

However it will be appreciated that none of the prior art discussed above i.e. AU 70170/81, EP 0199155 and U.S. Pat. No. 5,699,707 could be applied to cut fibre cement sheet in an efficient manner.

### SUMMARY OF THE INVENTION

It therefore is an object of the invention to provide cutting apparatus and process to alleviate at least one of the abovementioned disadvantages.

The invention, in one aspect, provides a method of cutting fibre cement sheet including the steps of:

(a) supporting an untrimmed fibre cement sheet on a conveyor belt formed from compressible or resilient material in contact with a rigid support surface whereby the fibre cement sheet is stationary on the belt;

(b) making two or more longitudinal cuts and two or more transverse cuts to the untrimmed sheet so as to trim at least four edges of the sheet, wherein each of said cuts are made in a vertical plane through the sheet and result in deformation of the compressible or resilient material which contacts the rigid support surface as a result of each cut; and

(c) removing the trimmed sheet from the conveyor belt.

The invention in another aspect refers to cutting apparatus for cutting compressed or uncompressed uncured fibre cement sheet which includes:

(i) a conveyor belt which is formed from compressible or resilient material;

(ii) a rigid support located below the conveyor belt which has a length which is approximately the same as an upper run of the conveyor belt, whereby, in use, after a cut is made to the fibre cement sheet, deformation of the resilient or compressible conveyor belt occurs and said conveyor belt contacts an upper surface of the rigid support; and

(iii) cutting means located above the conveyor belt for cutting of the fibre cement sheet, having at least one transverse cutting blade and at least one longitudinal cutting blade, wherein each of the cutting blades are oriented in a vertical plane in their cutting action and each of the cutting blades are vertically adjustable.

The conveyor belt may form part of a conveyor assembly which has a frame or body which supports a driven roller at one end and an idler roller at the other end. Suitably the driven roller is driven by a drive motor directly or via suitable reduction gearing.

The frame or body, however, has attached thereto or integral therewith the rigid support which may be formed from a block or table or plate formed of rigid material, such as steel, cast iron, or polymeric or plastics material, such as high density polyethylene. The rigid support also preferably has a top planar surface for contacting the conveyor belt in use.

The conveyor belt may be formed from natural rubber or synthetic rubber or other suitable compressible or resilient material. Suitable synthetic rubber includes butyl rubber, isoprene rubber, butadiene rubber, chloroprene rubber, nitrile-butadiene rubber or styrene butadiene rubber.

Most preferably the conveyor belt is formed from a variety of polyurethane and polyester blends. The most preferred material is POLYFLEX 30S.

The conveyor assembly may be stationary in use or alternatively may be movable such as having ground engaging wheels or alternatively having wheels which engage a suitable track.

The cutting means, in one form, may comprise a plurality of blades which are preferably adjustable so as to cater for differing dimensions of the fibre cement sheet. The fibre cement sheet is rectangular and thus the blades may comprise a rectangular array of four blades which are adjustable in both a longitudinal as well as a transverse direction. Each of the blades may be mounted to suitable mounting means which, in one form, may comprise a board having a plurality of rows of spaced slots wherein a blade is mounted in a particular row of slots so as to provide a desired setting relevant to particular dimensions.

If desired, there may be a plurality of rows of slots suitable for blades mounted transversely of the mounting board. A different series of rows of slots may be used for blades mounted longitudinally of the mounting board.

Alternatively and more preferably, there is used a single mounting board having the blades set to cut a sheet of particular dimensions (i.e. length and width). When it is desired to change the dimensions of the sheet, a new board is used having the blades set at the altered dimensions required.

Alternatively, a cutting board may be set up to cut a plurality of rectangular sheets (e.g. 2-3 or more). A cutting board may also be arranged to cut a multiplicity of planks (e.g. 3-8).

In another embodiment, the cutting means may comprise a mini cutting press or a series of mini cutting presses, each of which has a blade which can be used for making individual transverse or longitudinal cuts across or along the sheet of fibre cement sheet.

The blade may cut fully through the fire cement sheet to produce a clean cut edge without cutting the resilient conveyor belt which is fully supported at the location of the cut. The cutting action of the blade may be powered by hydraulic, pneumatic, electric, mechanical or other means.

Sheets of differing widths can be cut by simply adjusting the spacing of the longitudinal mini press unit blades to the desired width.

Furthermore, sheets of differing length can be cut by simply adjusting the spacing of the transverse mini press unit blades to the desired length.

A number of transverse mini press units could be mounted over one cutting conveyor to cut one, two or more sheets to their desired length.

A number of longitudinal mini press units could be mounted over another cutting conveyor to cut one, two or more sheets or planks to their desired width.

The cutting means, in another embodiment, may comprise an axle member having mounted thereto one, or more preferably, a plurality of cutting wheels having a sharpened peripheral edge. Each of the cutting wheels are preferably freely rotatable relative to the axle and may function in a similar manner to a pizza cutting wheel. The axle may be mounted to a suitable support or body and may be movable either transversely or longitudinally. To this end, there may be provided a pair of axles and attached cutting wheels with one axle movable longitudinally of the sheet and the other axle movable transversely of the sheet.

Alternatively, the axle may be dispensed with and each cutting wheel may be mounted for movement independent of each other, such as, for example, each cutting wheel having individual carriages which are capable of separative relative movement to the fibre cement sheet.

In yet another arrangement, each cutting wheel located longitudinally of the sheet may have its support shaft or axle fixed or stationary relative to a conveyor support frame while the conveyor moves the sheet through each cutting wheel.

In another arrangement, each longitudinal cutting wheel is mounted on a common axle and each transverse cutting wheel is mounted on an individual carriage wherein movement of each carriage is independent of each other.

There may also be provided an initial transfer conveyor belt for transferring fibre cement sheets onto the conveyor assembly of the invention which may have a similar structure to the conveyor assembly as described above with the omission of the rigid support.

There may also be provided a further conveyor assembly of similar structure to the initial conveyor assembly for receiving a trimmed fibre cement sheet which then may be transferred to another location, e.g. a transportation location or storage location.

The advantage of the conveyor belt contacting the rigid support in use and also having a deformation imparted thereto is of providing a clean cut through the fibre cement sheet as it takes into account small tolerances or variations between the cutting means and the sheet. For example, both the cutting board or axle as described above may not be in a position which is exactly co-planar or in a plane parallel with the fibre cement sheet.

The idler cutting wheels referred to above are particularly appropriate for cutting of uncured fibre cement sheet which is relatively soft compared to cured fibre cement sheet.

### BRIEF DESCRIPTION OF THE DRAWINGS

Reference may now be made to a preferred embodiment of the invention, wherein:

FIG. 1 is a side view of a processing plant which incorporates the sheet cutting apparatus of the invention;

FIG. 2 is a plan view of the processing plant of FIG. 1;

FIG. 3 is a side view of another form of processing plant which incorporates another form of cutting apparatus of the invention;

FIG. 4 is a plan view of the processing plant of FIG. 3;

FIG. 5 is a plan view of another kind of processing plant which incorporates another cutting apparatus of the invention;

FIG. 6 is a detailed perspective view of cutting apparatus used in the processing plant of FIG. 1;

FIG. 7 is a side view of the cutting apparatus shown in FIG. 6;

FIG. 8 is a detailed side view of the cutting action of the cutting apparatus shown in FIG. 6; and

FIG. 9 is a perspective view of another type of cutting apparatus used in FIG. 3.

### DETAILED DESCRIPTION OF THE DRAWINGS

In the drawings, there is shown processing plant 10 incorporating a transfer conveyor 11, an intermediate conveyor 12 on which fibre cement sheet is trimmed and a final conveyor 13 on which fibre cement sheet is subject to a further cutting or trimming operation.

The transfer conveyor 11 includes a vacuum pad or platen 14 having a pneumatic ram 15 and a pair of guides 16. The pneumatic ram 15 also includes a piston 17. The platen 14 transfers untrimmed fibre cement sheet 18 onto belt 19 of conveyor 11. Conveyor 11 also has a driving roller 21 driven by a drive motor (not shown) at one end and an idler roller 20 at the other end. Conveyor 11 also has a frame 22 which is supported by wheels 23 on tracks 24 which is provided with legs 25 and feet 26.

The intermediate conveyor 12 is also provided with a belt 27 made of resilient or compressible material and is supported by a metal sheet 28 made of rigid material, such as steel, or plastics material, such as high density polyethylene. There is also provided a driving roller 30 driven by a drive motor (not shown) and an idler roller 29.

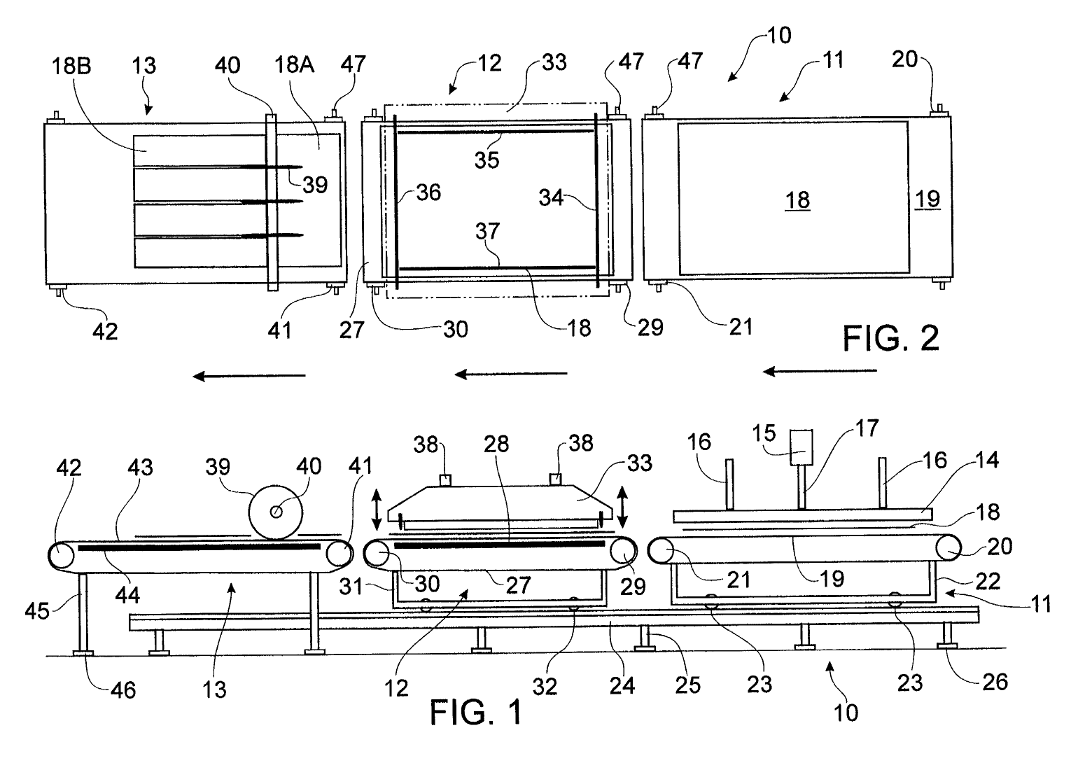

Intermediate conveyor 11 is also supported by frame 31 having wheels 32 engageable with tracks 24. There is also provided a cutting press or platen 33 having adjustable blades 34, 35, 36 and 37 arranged in a rectangular array as shown in FIG. 2. The fibre cement sheet 18 is also shown and each end and side is trimmed by blades 34, 35, 36 and 37 to the required dimensions to provide a trimmed sheet 18A. Cutting press 33, as is shown by the arrows in full outline, moves from an upper inoperative position to a lower operative or cutting position and vice versa. Cutting press 33 is also provided with support members 38. Movement of cutting press 33 is adjustable and carefully controlled to ensure that a clean cut is imparted to sheet 18 without damaging belt 27.

Finally, trimmed sheet 18A is transferred by intermediate conveyor 12 to final conveyor 13 wherein sheet 18A, if desired, may be further trimmed by cutting wheels 39 supported by a stationary axle 40. Belt 43 may move through cutting wheels 39 so as to trim sheet 18A into planks 18B if such is required. Conveyor 13 is also provided with a driving roller 42 driven by a drive motor (not shown) and idler roller 41. Conveyor 13 is also provided with a belt 43 formed from a resilient or compressible material and is also provided with a rigid support sheet 44. Conveyor 33 is stationary unlike conveyors 11 and 12 and is provided with legs 45 and feet 46.

Each of rollers 20, 21, 29, 30 and 41, 42 are supported on axles 47 as best shown in FIG. 2.

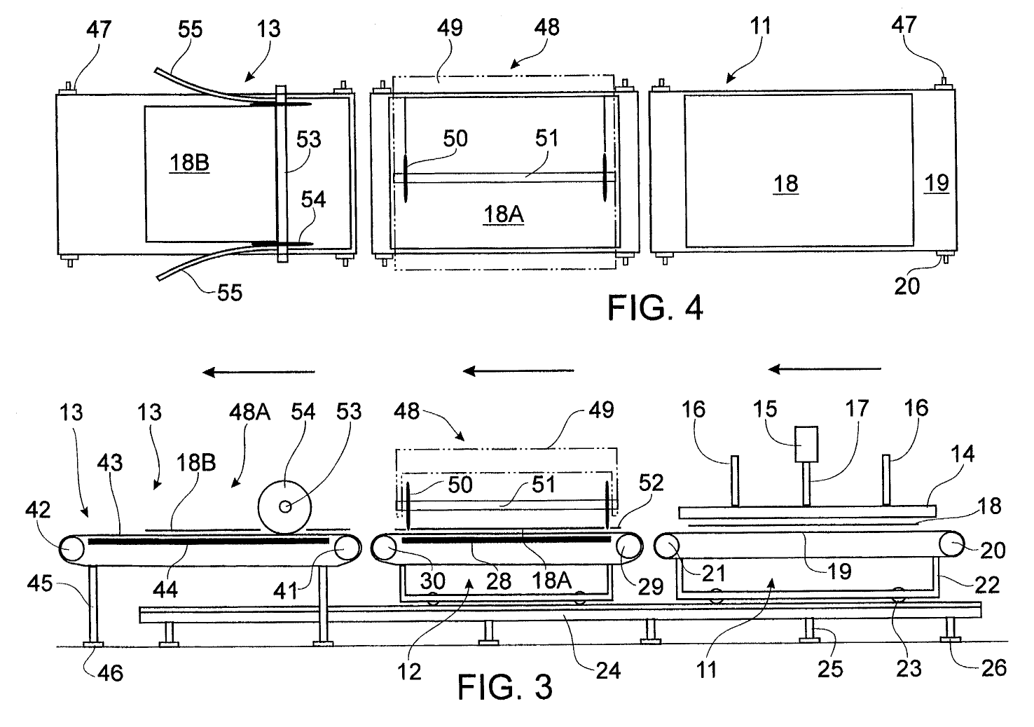

FIGS. 3-4 show a similar processing plant as described in FIGS. 1-2 and thus similar reference numerals have been used to describe the same conveyors used in FIGS. 1-2. Thus, FIGS. 3-4 also have transfer conveyor 11, intermediate conveyor 12 and final conveyor 13 as described in the embodiment of FIGS. 1-2.

However, in the FIGS. 3-4 embodiment, cutting press 33 has been replaced by cutting assembly 48. Cutting assembly 48 has a body or frame 49 shown in phantom and is provided with cutting wheels 50 attached to axle 51 which is movable from one side of sheet 18 to the other. Cutting wheels 50 are arranged so that they can cut the ends of fibre cement sheet 18 and thus axle 51 is arranged longitudinally in relation to conveyor 12 as shown.

Finally, sheet 18A with trimmed end edges is transferred onto conveyor 13 after removal of unwanted end portions 52. Such end portions 52 may be removed by being deposited on a scrap conveyor (not shown) located below conveyor 13. In this regard, it will be appreciated that such a scrap conveyor may be mounted below conveyors 11, 12 and 13 and movable longitudinally thereto. Alternatively, the scrap conveyor could be located below the junction of conveyors 12 and 13 and/or at the end of conveyor 13 and movable transversely thereto.

On conveyor 13, there is also provided cutting assembly 48A which comprises axle 53 and attached cutting wheels 54 for trimming side edges of sheet 18A to provide sheet 18B which is cut to the desired dimensions. Unwanted side portions 55 are discarded and sheet 1 8B is then removed from conveyor 13 for storage and/or further processing. Axle 53 is arranged transversely in relation to conveyor 13 as shown and preferably is stationary relative to movement of belt 43 in the cutting position.

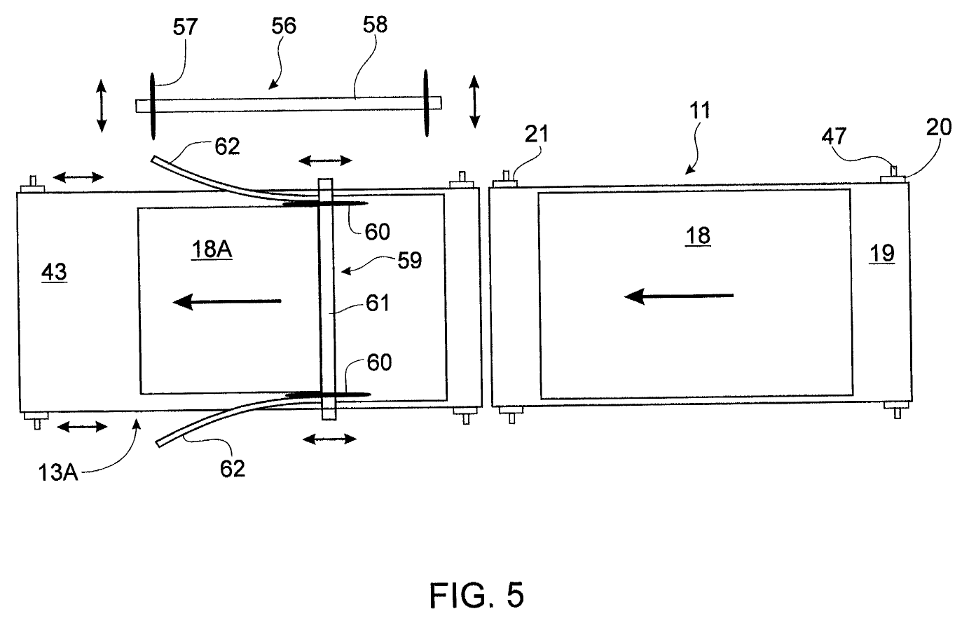

Another variation is shown in FIG. 5 wherein there are provided two cutting assemblies in relation to one conveyor wherein one cutting assembly 56 having cutting wheels 57 attached to axle 58 is moved transversely relative to conveyor 13A and another cutting assembly 59 having cutting wheels 60 attached to axle 61 is stationary relative to movement of belt 43 of conveyor 13A as shown to provide sheet 18A which is trimmed to the required dimensions by initial removal of side portions 62 which are discarded. It will be appreciated in FIG. 5 that after cutting operation of axle 61, movement of axle 58 may then be initiated or vice versa.

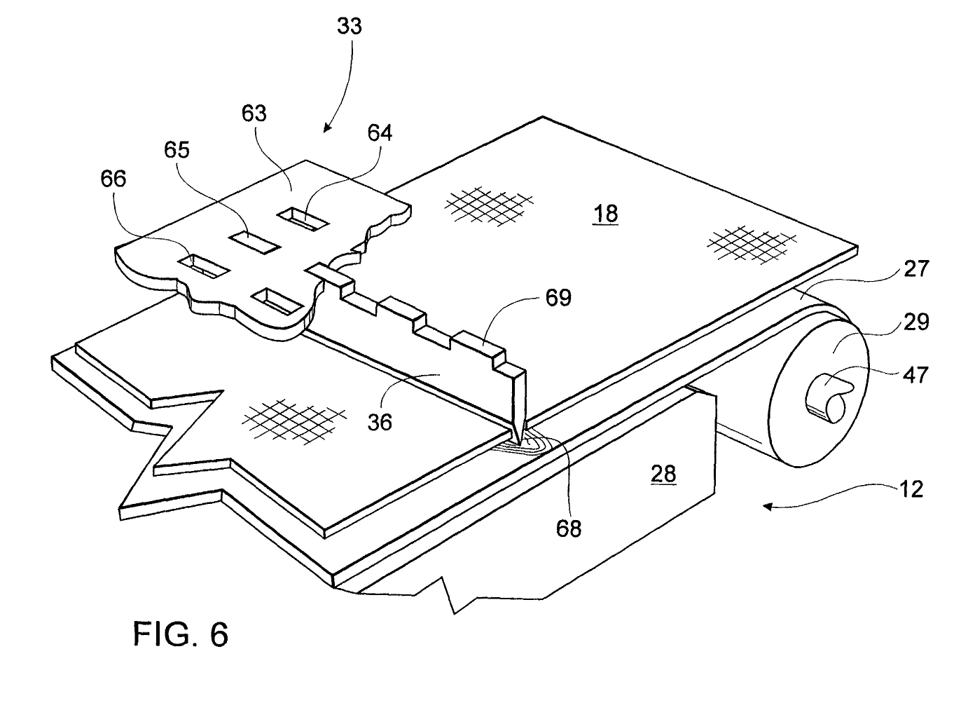

FIG. 6 shows a detailed view of cutting press 33 having board 63 located above sheet 18. Board 63 has slots 64, 65 and 66 arranged in spaced rows as shown whereby blade 36 having cutting edge 68 may be supported in a selected row depending upon the required finished dimensions of sheet 18. Cutting blade 36 has spaced projections 69 which are engageable in mating slots 65 as shown. Alternatively, board 63 may be provided with continuous slots replacing a row of spaced slots if desired. In this embodiment, the cutting blade may have a single elongate projection engageable in a mating slot.

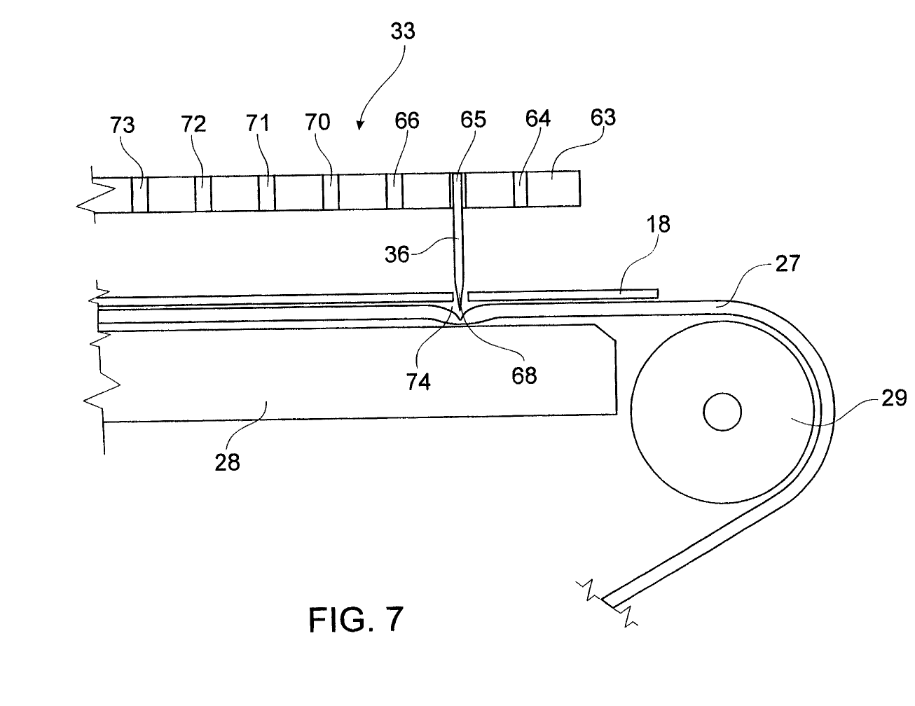

FIG. 7 shows cutting edge 68 of blade 36 forming a valley 74 in resilient conveyor belt 27 which is supported by rigid board or block 28.

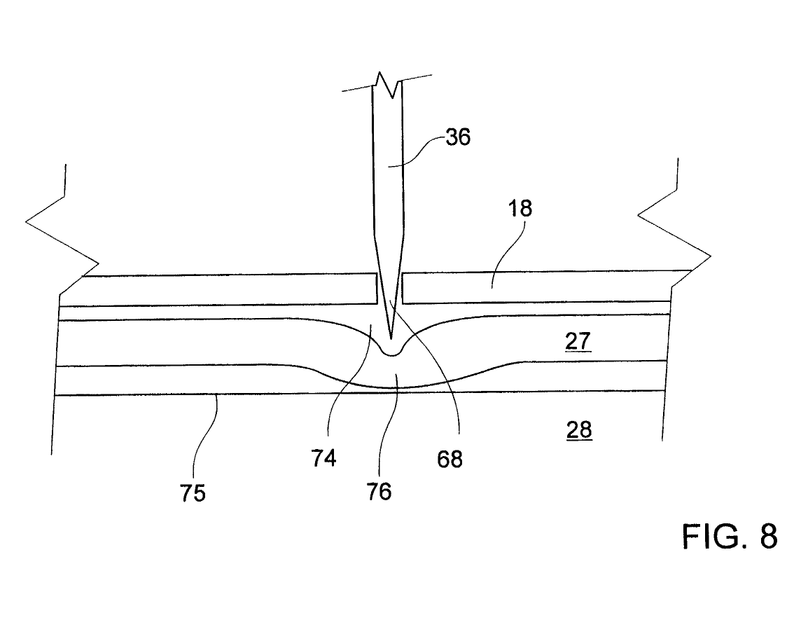

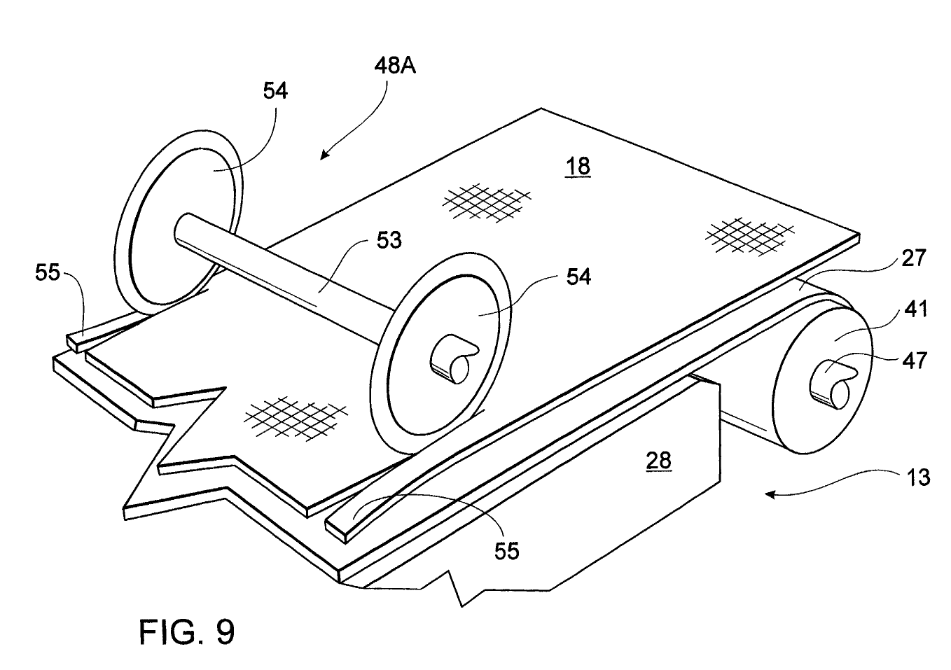

This is shown in greater detail in FIG. 8 wherein edge 68 after cutting fibre cement sheet 18 forms valley 74 thereby causing part of belt 27 to impact against bearing surface 75 of steel block 28 at 76. However, it will be appreciated that, in practice, deformation of belt 27 may not be so pronounced.

FIG. 9 shows a similar action in relation to cutting wheels 53 and 54 of cutting assembly 48A in regard to cutting side portions 55 of sheet 18.

In variations of the abovementioned embodiments, it will be appreciated that:

(A) when using cutting press 33, it often may be useful to dispense with axle 40 and attached cutting wheels 39 so that conveyor 13 may simply function as a collection point for removal of trimmed sheet 18A;

(B) the pneumatic ram 15 may be replaced by a hydraulically operated ram assembly or by an alternative mechanical equivalent;

(C) each of the blades 34, 35, 36 and 37 may have a single knife edge as indicated or alternatively, may be provided with a chisel edge where the cutting edge is located on one side and there is provided a bevel to the other side of the blade. The cutting wheels may have a similar arrangement;

(D) the cutting press 33 may also be provided with additional blades (not shown) to vary the shape of the sheet in the form of longitudinal strips or planks if desired or provide polygonally shaped sheets;

(E) a transfer conveyor may be used to move untrimmed sheet 18 onto conveyor 11 instead of the vacuum lifting device 15;

(F) all of the cutting wheels illustrated are adjustable vertically be they mounted to an axle or carriage to ensure optimum contact with the fibre cement sheet;

(G) it is possible to remove the trimmed fibre cement sheet from conveyor 13 by a vacuum pad (not shown) if desired and leave the swarf or waste on the conveyor belt 43. Alternatively, sheet 18b may be transferred to another conveyor leaving the waste to be deposited into a receptacle at one end thereof.

From the foregoing, it will be appreciated that the cutting apparatus of the invention, which involves the resilient conveyor belt and rigid support block, provides substantial advantages over the prior art in that a clean cut is made through the fibre cement sheet even though the cutting board 63 or axle supporting the cutting wheels may not be in a plane which is perfectly co-planar or square with the fibre cement sheet. This means that cycle times (i.e. processing time for one fibre cement sheet) may be reduced to 6-8 seconds. Also, the provision of the conveyor belt assembly simplifies the cutting process when compared to the prior art.

The provision of the free spinning or freely rotatable cutting wheels also is a feature of the invention that greatly reduces the complexity of the cutting board 63 wherein the time for adjustment of the cutting blades was often found to be time consuming.

It will also be appreciated that another advantage of the invention is that the trimmed fibre cement sheet does not require any further edge trimming after curing which is a great saving of time and costs associated with raw material and waste disposal. This makes the process and apparatus of the invention less labour intensive and more economic.

A further advantage of the invention is that the edges of the cut fibre cement sheets are trimmed cleanly, smoothly and in a dimensionally accurate manner without dags or bits attached to the cut edges.

As the blades of the cutting means wear in use, they may be progressively adjusted to ensure a clean cut to the fibre cement sheets. This also provides a significant increase in blade longevity compared to the prior art. This provides significant cost saving.

The invention also provides lower manufacturing costs of fibre cement sheet due to lower maintenance and preliminary set up requirements as well as reduced frequency and duration of machine downtime.

It also will be appreciated that because uncompressed or compressed fibre cement sheet is relatively soft, the cushioning effect obtained by the resilient or copmressible conveyor belt contacting the rigid support with a slight deformation of hte conveyor belt achieves a clean cut through the fibre cement sheet which avoids the problems of the prior art.

1. A method of cutting compressed or uncompressed uncured fibre cement sheet including the steps of:
(a) supporting an untrimmed fibre cement sheet on a conveyor belt formed from compressible or resilient material in contact with a rigid support surface whereby the fibre cement sheet is stationary on the belt;
(b) making two or more longitudinal cuts and two or more transverse cuts to the untrimmed sheet so as to trim at least four edges of the sheet, wherein each of said cuts are made in a vertical plane through the sheet and result in deformation of the compressible or resilient material which contacts the rigid support surface as a result of each cut; and
(c) removing the trimmed sheet from the conveyor belt.

2. A method as claimed in claim 1, wherein each of said transverse cuts are made simultaneously.

3. A method as claimed in claim 1, wherein each of said longitudinal cuts are the made simultaneously.

4. A method as claimed in claim 1, wherein each of said transverse cuts and each of said longitudinal cuts are made simultaneously.

5. A method as claimed in claim 1, wherein more than two longitudinal cuts are made to cut the sheet into a plurality of longitudinal planks.

6. Cutting apparatus for cutting compressed or uncompressed uncured fibre cement sheet which includes:
(i) a conveyor belt which is formed from compressible or resilient material;
(ii) a rigid support located below the conveyor belt which has a length which is approximately the same as an upper run of the conveyor belt, whereby, in use, after a cut is made to the fibre cement sheet, deformation of the resilient or compressible conveyor belt occurs and said conveyor belt contacts an upper surface of the rigid table; and
(iii) cutting means located above the conveyor belt for cutting of the fibre cement sheet, having at least one transverse cutting blade and at least one longitudinal cutting blade, wherein each of the cutting blades are oriented in a vertical plane in their cutting action and each of the cutting blades are vertically adjustable.

7. Cutting apparatus as claimed in claim 6, wherein the cutting apparatus comprises a rectangular array of four blades.

8. Cutting apparatus as claimed in claim 7, wherein two blades are adjustable in a longitudinal direction and the other two blades are adjustable in a transverse direction.

9. Cutting apparatus as claimed in claim 6, wherein said at least one longitudinal cutting blade is a circular blade of a freely rotating cutting wheel oriented in a longitudinal direction and said at least one transverse cutting blade is a circular blade of a freely rotating cutting blade oriented in a transverse direction.

10. Cutting apparatus as claimed in claim 9, wherein there is provided a pair of freely rotating longitudinal cutting wheels for cutting side edges of a fibre cement sheet and there is provided a pair of freely rotating transverse cutting wheels for cutting end edges of the fibre cement sheet.

11. Cutting apparatus as claimed in claim 10, wherein each cutting wheel is fixed or stationary relative to the conveyor belt which in use moves the fibre cement sheet through each cutting wheel.

12. Cutting apparatus as claimed in claim 10, wherein each of the cutting wheels are moveable relative to the conveyor belt.

13. Cutting apparatus as claimed in claim 10, wherein the pair of longitudinal cutting wheels are attached to a transverse axle and the pair of transverse cutting wheels are attached to a longitudinal axle.

14. Cutting apparatus as claimed in claim 6, wherein there is provided an initial conveyor belt for transferring fibre cement sheets onto the conveyor belt formed from resilient or compressible material.

15. Cutting apparatus as claimed in claim 6, wherein there is provided a final conveyor belt for receiving a trimmed fibre cement sheet for transfer to a storage or transportation location.
